(19) United States
(12) Patent Application Publication
(10) Pub. No.: US 2005/0158478 A1
(43) Pub. Date: Jul. 21, 2005

(54) Substrate processing apparatus and substrate processing method

(76) Inventors: Seiji Katsuoka, Tokyo (JP); Masahiko Sekimoto, Tokyo (JP); Teruyuki Watanabe, Tokyo (JP); Takahiro Ogawa, Tokyo (JP); Kenichi Kobayashi, Tokyo (JP); Mitsuru Miyazaki, Tokyo (JP); Yasuyuki Motojima, Tokyo (JP); Toshio Yokoyama, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/514,030

(22) PCT Filed: May 30, 2003
(86) PCT No.: PCT/JP03/06822

(30) Foreign Application Priority Data
Jun. 6, 2002 (JP) 2002-165213
Nov. 15, 2002 (JP) 2002-332697

(51) Int. Cl. B05D 1/18; B05C 3/00

(52) U.S. Cl. 427/437; 205/157; 118/400

(57) ABSTRACT

A substrate processing apparatus has a processing tank (10) for plating a substrate (W) in a plating solution (Q) holds therein, a cover (40) for selectively opening and closing an opening (11) of the processing tank (10), a spraying nozzle (60) mounted on an upper surface of the cover (40), and a substrate head (80) for attracting a reverse side of the substrate (W) to hold the substrate (W). With the cover (40) removed from the opening (11) of the processing tank (10), the substrate head (80) is lowered to dip the substrate (W) in the plating solution (Q) for thereby plating the substrate (W). When the substrate head (80) is lifted and the opening (11) of the processing tank (10) is closed by the cover (40), the substrate (W) is cleaned by the spraying nozzle (60).

### TECHNICAL FIELD

The present invention relates to a substrate processing apparatus and substrate processing method which are suitable for processing a substrate with a plurality of liquids.

### BACKGROUND ART

A process of embedding a metal (conductor) in interconnection trenches and contact holes (so-called damascene process) is being used as a process of forming interconnects on semiconductor substrates. This process is a process technology for embedding aluminum or, in recent years, a metal such as copper, silver or the like (interconnection material) in interconnection trenches and contact holes that have been formed in an interlevel dielectric, and thereafter removing excessive metal by chemical mechanical polishing (CMP) to produce a planarized surface. For example, as shown in FIG. 15 of the accompanying drawings, a minute interconnection recess 212 is formed in an insulating film 210 of SiO₂ or the like that has been deposited on the surface of a substrate W such as a semiconductor wafer. After a barrier layer 214 of TaN or the like is formed on the surface of the minute interconnection recess 212, the insulating film 210 is plated with copper, thus growing a copper film on the surface of the substrate W and filling the minute interconnection recess 212 with copper (a damascene process). Thereafter, chemical mechanical polishing (CMP) is performed on the surface of the substrate W to remove excess copper film therefrom to planarize the surface of the substrate W, thereby forming an interconnection 216 of copper film in the insulating film 210. Then, an interconnection protective layer (cap material) 218 composed of a Co—W—P alloy film deposited by electroless plating, for example, is selectively formed on the exposed surface of the interconnection (copper film) 216, thereby protecting the interconnection 216 with the interconnection protective layer 218 (cap plating process).

Heretofore, plating apparatus generally comprises a plurality of units including a unit for carrying out various plating processes, a unit for carrying out various preprocessing processes ancillary to the plating processes, and a unit for carrying out a cleaning process. There has been proposed a plating apparatus for carrying out the above various processes with a single unit, as a substitute for the above conventional plating apparatus.

However, if a plurality of processes (e.g., a chemical liquid process using a plating solution, a cleaning process using pure water, or a plurality of chemical liquid processes) are carried out by one unit, then the processing liquids used in the respective processes are mixed or diluted, and cannot be reused.

### DISCLOSURE OF INVENTION

The present invention has been made in view of the above drawbacks. It is an object of the present invention to provide a substrate processing apparatus and substrate processing method which are capable of preventing processing liquids from being mixed with each other even when a substrate is processed with a plurality of processing liquids in one apparatus.

To achieve the above object, an apparatus for processing a substrate according to the present invention has a first processing section bringing a processing liquid into contact with a surface to be processed of a substrate in such a state that the substrate held by a substrate head is inserted in a processing tank; a substrate lifting/lowering mechanism for vertically moving the substrate held by the substrate head; a cover for selectively opening and closing an opening of the processing tank; and a second processing section for bringing a processing liquid into contact with the surface to be processed of the substrate held by the substrate head, above the cover which has closed the opening of the processing tank.

With the above arrangement, while the opening of the processing tank of the first processing section is being closed by the cover, the substrate can be brought into contact with the other processing liquid by the second processing section. Therefore, when the substrate is brought into contact with the other processing liquid by the second processing section, the processing liquid used by the second processing section does not enter the processing tank, and hence is prevented from being mixed with the processing liquid in the processing tank. The apparatus is made compact because a plurality of substrate processing steps are carried out respectively within and above the processing tank.

For example, the first processing section is of a structure for storing the processing liquid in the processing tank and dipping the surface to be processed of the substrate in the processing liquid thereby to bring the processing liquid into contact with the surface to be processed of the substrate.

Preferably, the processing tank is adapted to eject and seal a gas therein.

The first processing section may be of a structure for bringing a processing liquid, which is ejected from a processing liquid ejecting section disposed in the processing tank, into contact with the surface to be processed of the substrate.

The processing tank preferably has a processing liquid circulating system for retrieving the processing liquid which has been supplied to the processing tank and supplying the processing liquid to the processing tank. With the processing liquid circulating system, the liquid used by the second processing section is prevented from entering the processing tank, and the processing liquid in the processing tank can easily be circulated for reuse.

The substrate head is preferably of a structure for attracting a reverse side of the substrate to hold the substrate thereby to bring the processing liquid into contact with the entire surface to be processed of the substrate. Therefore, the entire surface to be processed of the substrate, including an edge of the substrate, can easily be processed.

Preferably, the substrate head is of a structure for attracting only a reverse side of the substrate to hold the substrate thereby to produce a uniform flow of the processing liquid to be brought into contact with the surface to be processed of the substrate, and bring the processing liquid into uniform contact with the entire surface to be processed of the substrate, including an edge of the substrate. Therefore, the entire surface to be processed of the substrate, including an edge of the substrate, can uniformly be processed.

Preferably, the substrate head has a swinging mechanism for dipping the substrate held by the substrate head in the processing liquid in the processing tank while the substrate is being inclined a predetermined angle from a horizontal position. Since the substrate can be dipped in the processing liquid while being inclined a predetermined angle from a horizontal position, a gas such as air or the like is prevented from remaining on the surface to be processed of the substrate, and the surface to be processed of the substrate can uniformly be processed.

The apparatus should preferably further comprise an actuating mechanism for moving the cover between two positions including a retracted position in which the cover is positioned on a side of the processing tank and a closing position in which the cover is positioned above the processing tank and closes the opening of the processing tank. Since the cover is positioned only above the processing tank and on the side of the processing tank, the overall substrate processing apparatus is made compact.

Preferably, a processing liquid ejecting section is provided on an upper surface of the cover for bringing the processing liquid into contact with the surface to be processed of the substrate while the cover is closing the opening of the processing tank. With the processing liquid ejecting section (spraying nozzle) being provided as the second processing section integrally on the upper surface of the cover, the apparatus can be simplified.

A bank may be provided on an upper surface of the cover for preventing the processing liquid remaining on the upper surface of the cover from falling into the processing tank when the cover is opened from a state in which the cover closes the opening of the processing tank. The bank is effective in reliably preventing the liquid used to process the substrate with the second processing section from flowing into the processing tank.

The cover may have an upper surface having a slanted shape or a conical shape for allowing the processing liquid on the upper surface of the cover to flow down while the cover is closing the opening of the processing tank. The upper surface thus shaped of the cover is effective in reliably preventing the liquid used to process the substrate with the second processing section from flowing into the processing tank.

The apparatus may further comprise a wiper, a vibrator, or a cover rotating mechanism for removing the processing liquid which remains on an upper surface of said cover. The wiper, the vibrator, or the cover rotating mechanism is effective in reliably preventing the liquid used to process the substrate with the second processing section from flowing into the processing tank.

Preferably, the processing tank has on an upper portion thereof a slanted wall having an outside diameter which is progressively smaller in an upward direction, such that an outer wall at an upper end of the opening of said processing tank is positioned inwardly of an inner wall of said cover which covers the upper end of the opening. The slanted wall is effective in reliably preventing the liquid used to process the substrate with the second processing section from flowing into the processing tank.

A method of processing a substrate according to the present invention, comprises: bringing a processing liquid into contact with a surface to be processed of a substrate in such a state that the substrate held by a substrate head is inserted in a processing tank; closing an opening of the processing tank with a cover in such a state that the substrate held by the substrate is lifted above the processing tank; and bringing a processing liquid into contact with the surface to be processed of the substrate held by the substrate head, above the cover which has closed the opening of the processing tank.

The bringing the processing liquid into contact with the surface to be processed of the substrate in the processing tank comprises the steps of storing the processing liquid in the processing tank and dipping the surface to be processed of the substrate in the processing liquid.

Preferably, the method further comprises the filling the processing tank with an inactive gas when the opening of the processing tank is closed by the cover, thereby protecting the processing liquid in the processing tank.

The bringing the processing liquid into contact with the surface to be processed of the substrate in the processing tank alternatively comprises the step of ejecting a processing liquid ejected from a processing liquid ejecting section disposed in the processing tank into contact with the surface to be processed of the substrate.

The method should preferably further comprise retrieving the processing liquid which has been supplied to the processing tank and supplying the processing liquid to the processing tank.

The substrate head preferably attracts a reverse side of the substrate to hold the substrate.

Preferably, the substrate head attracts only a reverse side of the substrate to hold the substrate thereby to produce a uniform flow of the processing liquid to be brought into contact with the surface to be processed of the substrate, and bring the processing liquid into uniform contact with the entire surface to be processed of the substrate, including an edge of the substrate.

Preferably, the uniform flow of the processing liquid discharges, from the surface to be processed, air bubbles flowing onto the surface to be processed of the substrate or air bubbles generated when the processing liquid is brought into contact with the surface to be processed of the substrate.

The dipping the surface to be processed of the substrate in the processing liquid should preferably comprise the step of dipping the surface to be processed of the substrate in the processing liquid in the processing tank while said substrate is being tilted.

Preferably, the opening of the processing tank is selectively opened and closed by the cover by moving the cover between two positions including a retracted position in which the cover is positioned on a side of the processing tank and a closing position in which the cover is positioned above the processing tank and closes the opening of the processing tank.

The bringing the processing liquid into contact with the surface to be processed of the substrate above the cover may comprise the step of ejecting a processing liquid ejected from a processing liquid ejecting section mounted on an upper surface of said cover to the substrate.

### BRIEF DESCRIPTION OF DRAWINGS

FIG. 1A is a side view of a substrate processing apparatus for use as an electroless plating apparatus according to an embodiment of the present invention;

FIG. 1B is a sectional side view schematically showing the substrate processing apparatus;

FIG. 2 is an enlarged fragmentary cross-sectional view showing the dimensional relationship between a cover and an outer circumferential portion of a processing tank when the cover is moved to a position above the processing tank;

FIG. 3A is a cross-sectional view schematically showing a substrate head at the time of transferring a substrate;

FIG. 3B is an enlarged view of a portion B in FIG. 3A;

FIG. 4A is a cross-sectional view schematically showing the substrate head at the time of holding the substrate;

FIG. 4B is an enlarged view of a portion B in FIG. 4A;

FIG. 5A is a cross-sectional view schematically showing the substrate head at the time of plating the substrate;

FIG. 5B is an enlarged view of a portion B in FIG. 5A;

FIG. 6 is a side view schematically showing a structure of a substrate head actuating mechanism;

FIG. 7A is a side view illustrative of operation (first process) of the substrate processing apparatus;

FIG. 7B is a sectional side view schematically showing illustrative of operation (first process) of the substrate processing apparatus;

FIG. 8A is a side view illustrative of operation (second process) of the substrate processing apparatus;

FIG. 8B is a sectional side view schematically showing illustrative of operation (second process) of the substrate processing apparatus;

FIG. 9A is a plan view of the processing tank with another cover mounted thereon;

FIG. 9B is a side view of the processing tank;

FIG. 10A is a plan view of the processing tank with still another cover mounted thereon;

FIG. 10B is a side view of the processing tank;

FIG. 11A is a plan view of the processing tank with still another cover mounted thereon;

FIG. 11B is a side view of the processing tank;

FIG. 12A is a plan view of the processing tank with still another cover mounted thereon;

FIG. 12B is a side view of the processing tank;

FIG. 13A is a plan view of the processing tank with still another cover mounted thereon;

FIG. 13B is a side view of the processing tank;

FIG. 14A is a plan view of the processing tank with a still another cover mounted thereon;

FIG. 14B is a side view of the processing tank shown in section partly;

FIG. 14C is an enlarged view of a portion C in FIG. 14B;

FIG. 14D is a right side view of the processing tank with the cover shown in section;

FIG. 15 is an enlarged fragmentary cross-sectional view of a semiconductor substrate;

FIG. 16 is a plan view showing the layout of a substrate processing mechanism that is provided with the substrate processing apparatus;

FIG. 17 is a plan view showing the layout of another substrate processing mechanism;

FIG. 18 is a plan view showing the layout of still another substrate processing mechanism;

FIG. 19 is a flowchart showing a flow of processes in the substrate processing mechanism shown in FIG. 18;

FIG. 20 is a view schematically showing a bevel and backside cleaning unit;

FIG. 21 is a vertically sectional front view of an example of an annealing unit;

FIG. 22 is a sectional plan view of the annealing unit shown in FIG. 21;

FIG. 23 is a sectional side view schematically showing a substrate processing apparatus according to another embodiment of the present invention; and

FIG. 24 is a view showing a processing tank and a cover of a substrate processing apparatus according to still another embodiment of the present invention.

### BEST MODE FOR CARRYING OUT THE INVENTION

Embodiments of the present invention will be described below in detail with reference to the drawings.

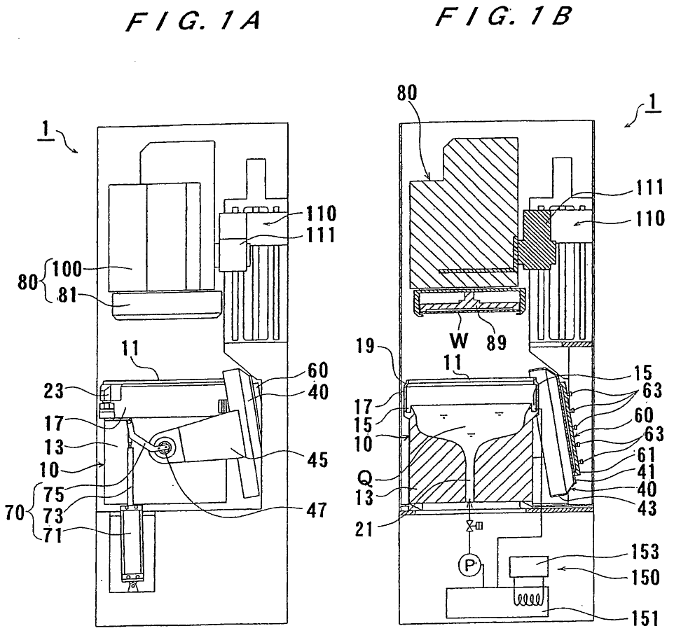

FIG. 1A is a side view of a substrate processing apparatus 1 for use as an electroless plating apparatus according to an embodiment of the present invention, and FIG. 1B is a sectional side view schematically showing the substrate processing apparatus 1. As shown in FIGS. 1A and 1B, the substrate processing apparatus (electroless plating apparatus) 1 comprises a processing tank (first processing section) 10 for dipping a substrate W in a plating solution (processing liquid) Q held therein, a cover 40 for closing an opening 11 of the processing tank 10, a spraying nozzle (second processing section) 60 mounted on an upper surface of the cover 40, an actuating mechanism 70 for actuating (turning) the cover 40, a substrate head 80 for holding the substrate W, a substrate head actuating mechanism 110 for actuating the substrate head 80 in its entirety, and a processing liquid circulating system 150 for circulating the plating solution Q held in the processing tank 10. These components will be described below.

The processing tank 10 comprises a processing tank body 13 for holding the plating solution Q therein, an outer circumferential groove 15 defined in an outer circumferential portion of the upper end of the processing tank body 13 for retrieving the plating solution Q which has overflowed the processing tank body 13, and a tubular hood 17 projecting upwardly in surrounding relation to the outer circumferential side of the outer circumferential groove 15. The tubular hood 17 has on its upper edge a slanted wall 19 whose outer diameter is progressively reduced in the upward direction. The processing tank body 13 has a plating solution supply port 21 defined centrally in the bottom thereof. A rinsing nozzle 23 is mounted on the tubular hood 17 for ejecting a shot of cleaning liquid (pure water) from an inner sidewall of the tubular hood 17 toward the opening 11.

The processing liquid circulating system 150 is adapted to return the plating solution Q that has overflowed the processing tank 10 into the outer circumferential groove 15 back to a supply tank 151 through a pipe, and supply the plating solution held in the supply tank 15 to the plating solution supply port 21 of the processing tank body 13 with a pump P, thereby circulating the plating solution Q. The supply tank 151 houses therein a heater 153 for keeping the plating solution Q to be supplied to the processing tank 10 at a predetermined temperature.

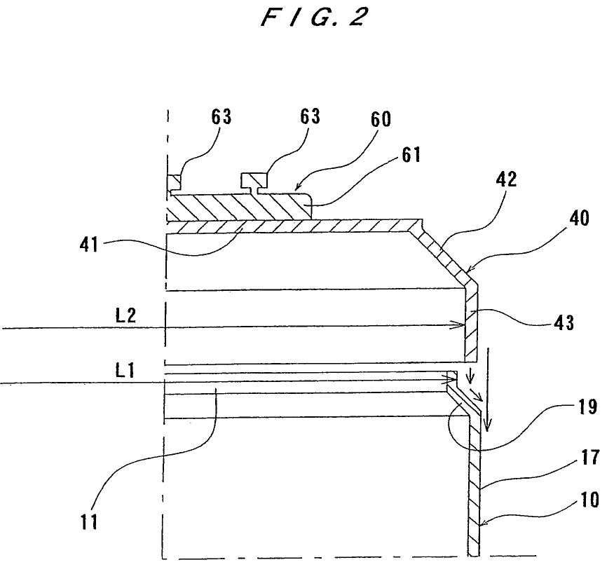

The cover 40 is composed of a plate member having such a size as to cover the opening 11 of the processing tank 10. The cover 40 has a substantially circular upper panel 41, a side panel 43 surrounding the outer circumferential edge of the upper panel 41, and a slanted panel 42 (see FIG. 2) interconnecting the upper panel 41 and the side panel 43. A pair of plate-like arms 45 is mounted on opposite sides of the cover 40. The plate-like arms 45 are angularly movably supported at portions near their distal ends on respective pivot shafts 47 that are disposed on substantially central opposite sides of the processing tank 10. The distal end of one of the arms 45 is fixed to a tip end of a coupling arm 75 of the actuating mechanism 70.

FIG. 2 is an enlarged fragmentary cross-sectional view showing the dimensional relationship between the cover 40 and the outer circumferential portion of the processing tank 10 when the cover 40 is moved to a position above the processing tank 10. As described above, the tubular hood 17 has on its upper edge the slanted wall 19 whose outer diameter is progressively reduced in the upward direction. With the slanted wall 19 thus shaped, the outer wall surface (outside diameter L1) at the upper end of the opening 11 of the processing tank 10 is positioned inwardly of the inner wall surface (inside diameter L2) of the cover 40 which covers the upper end of the opening 11 (L1<L2).

The spraying nozzle (processing liquid ejecting section) 60 comprises a plurality of (five) upwardly oriented nozzles 63 mounted in an array on a single bar-shaped mount block 61 attached centrally to the upper surface of the cover 40. The nozzles 63 spray, in this embodiment, the cleaning liquid (pure water) directly upwardly. The mount block 61 has corners (on sides and vertexes thereof) rounded off to prevent the pure water or another liquid from remaining on the spraying nozzle 60 when the cover 40 is turned.

Referring back to FIGS. 1A and 1B, the actuating mechanism 70 comprises a cover turning cylinder 71, a rod 73 connected to a piston in the cover turning cylinder 71, and a coupling arm 75 angularly movably coupled to the distal end of the rod 73. The cover turning cylinder 71 has a lower end angularly movably supported on a fixed member side.

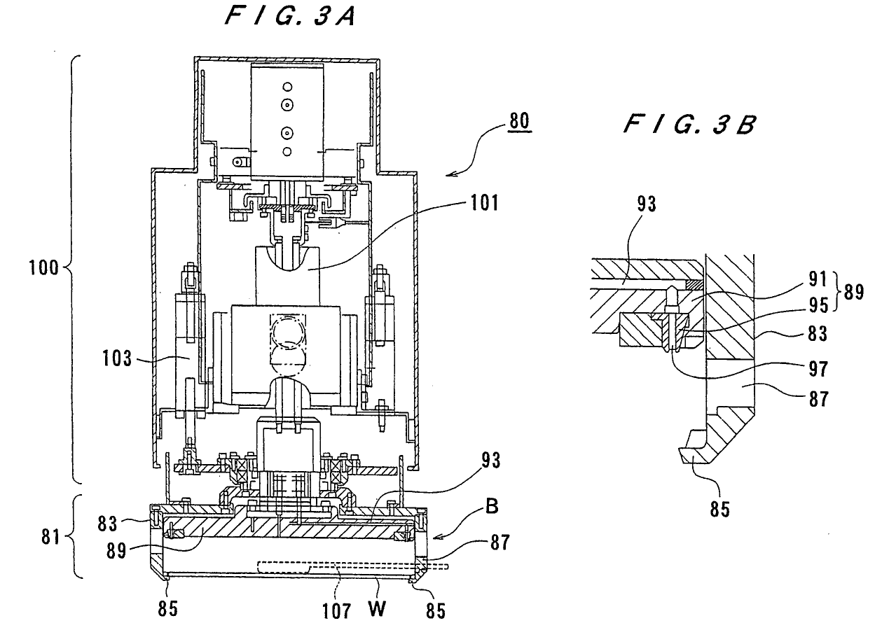

FIG. 3A is a cross-sectional view schematically showing the substrate head 80, and FIG. 3B is an enlarged view of a portion B in FIG. 3A. As shown in FIG. 3A, the substrate head 80 has a substrate holder 81 and a substrate holder actuating section 100. The substrate holder 81 comprises a substantially cylindrical substrate receiver 83 which is open facing downwardly, and a substantially circular suction head 89 disposed inside the substrate receiver 83. The substrate receiver 83 has a temporary rest 85 projecting inwardly from its lower end for temporarily placing the substrate W thereon, and a substrate insertion slot 87 defined in an outer circumferential sidewall thereof. The suction head 89 comprises a substantially circular base 91 having a vacuum/gas supply line 93 formed therein, and a ring-shaped substrate attracting member 95 mounted on a lower surface of the base 91. The substrate attracting member 95 is composed of a sealing member having a distal end projecting downwardly from the lower surface of the base 91 for sealing the reverse side of the substrate W which is held against the sealing member. The substrate attracting member 95 has a suction/release hole 97 formed therein which is connected to the vacuum/gas supply line 93 for selectively attracting and releasing the substrate W.

The substrate holder actuating section 100 has therein a substrate rotating motor 101 for rotating the suction head 89 and a substrate receiver moving cylinder 103 for moving the substrate receiver 83 to predetermined vertical positions (at least three vertical positions). The suction head 89 is rotated by the substrate rotating motor 101, and the substrate receiver 83 is vertically moved by the substrate receiver moving cylinder 103. The suction head 89 is rotated, but not moved vertically, and the substrate receiver 83 is moved vertically, but not rotated.

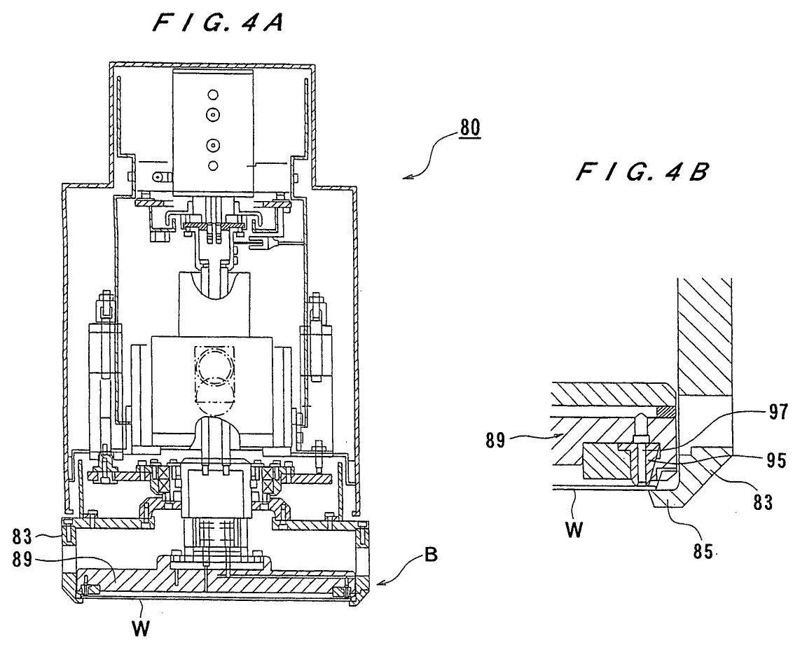

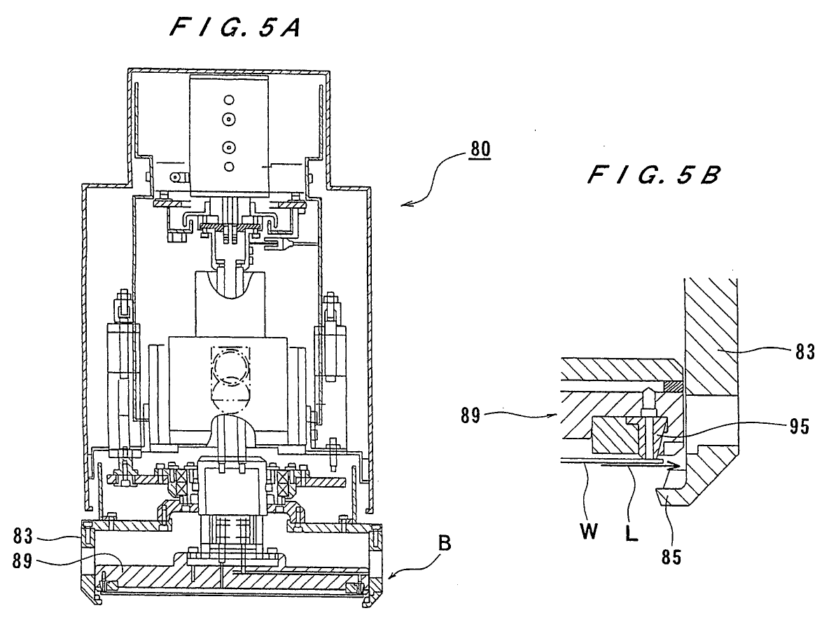

Operation of the substrate head 80 will be described below. As shown in FIGS. 3A and 3B, with the suction head 89 not rotated, the substrate receiver 83 is moved to a lowermost position (substrate transfer position), and a substrate W attracted by a substrate feed hand 107 is inserted through the substrate insertion slot 87 into the substrate receiver 83. Then, the substrate W is released from the substrate feed hand 107 and placed on the temporary rest 85. At this time, the surface to be processed of the substrate W faces downwardly. The substrate feed hand 107 is then removed from the substrate insertion slot 87. Then, as shown in FIGS. 4A and 4B, the substrate receiver 83 is lifted to contact and press the tip end of the substrate attracting member 95 against the outer circumferential portion of the reverse side (upper surface) of the substrate W, and the suction/release hole 97 is evacuated to attract the substrate W against the substrate attracting member 95. The position of the substrate receiver 83 at this time is referred to as a substrate fixing position. The reverse side of the substrate W (the surface opposite to the surface to be processed) is now isolated from the surface to be processed by being sealed by the substrate attracting member 95. Since a circumferential area, which is narrow width (diametrically direction) of the substrate W, is evacuated according to the above attracting process, adverse effects (such as flexing) posed on the substrate W by the evacuation are minimized. Then, as shown in FIGS. 5A and 5B, the substrate receiver 83 is lowered slightly (by several mm, for example) to release the substrate W from the temporary rest 85. The position of the substrate receiver 83 at this time is referred to as a substrate processing position. Then, the substrate head 80 is lowered in its entirety to dip the substrate W held by the substrate head 80 in the plating solution Q in the processing tank 10 shown in FIG. 1. Since only the reverse side of the substrate W is attracted, the entire surface to be processed of the substrate W and the edge portion thereof can be dipped entirely in the plating solution and processed thereby. Furthermore, because the substrate receiver 83 is lowered off the substrate W and only the reverse side of the substrate W is attracted, a flow L (see FIG. 5B) of the plating solution Q against the substrate W is not impeded when the substrate W is dipped in the plating solution Q, so that the plating solution Q flows uniformly over the entire surface to be processed of the substrate W. Air bubbles flowing together with the flow of the plating solution Q onto the surface to be processed of the substrate W and air bubbles produced by the plating process can be discharged from the surface to be processed of the substrate W into another region in the processing tank 10. Accordingly, irregular flows or air bubbles, which would otherwise adversely affect the plating process, are removed, so that the entire surface, including the edge portion, to be processed of the substrate W can be plated uniformly. After the processing of the substrate W is completed, the substrate receiver 83 is lifted to the substrate fixing position shown in FIGS. 4A and 4B, placing the substrate W on the temporary rest 85. A gas (inactive gas such as nitrogen gas, for example) is ejected from the suction/release hole 97 to release the substrate W from the substrate attracting member 95. At the same time, the substrate receiver 83 is lowered to the substrate transfer position shown in FIGS. 3A and 3B. Thereafter, the substrate feed hand 107 is inserted from the substrate insertion slot 87, and pulls the substrate W out of the substrate receiver 83.

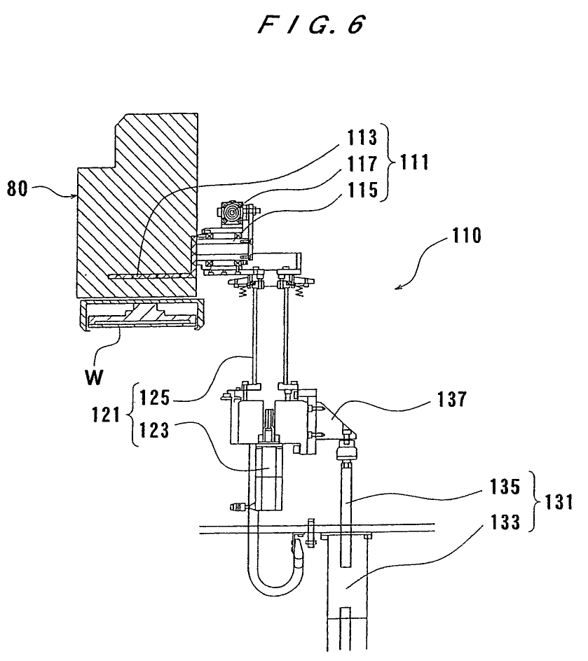

FIG. 6 is a side view schematically showing a structure of the substrate head actuating mechanism 110. As shown in FIG. 6, the substrate head actuating mechanism 110 comprises a swinging mechanism 111 for swinging the substrate head 80 in its entirety, a turning mechanism 121 for turning the substrate head 80 and the swinging mechanism 111 in their entirety, and a lifting/lowering mechanism 131 for lifting and lowering the substrate head 80, the swinging mechanism 111, and the turning mechanism 121 in their entirety. The swinging mechanism 111 comprises a shaft 115 secured to a bracket 113 which is fixed to the substrate head 80, and a shaft rotating cylinder 117 for rotating the shaft 115. When the shaft rotating cylinder 117 is actuated, the shaft 115 is rotated a predetermined angle to swing the substrate head 80 for selectively moving the substrate W held by the substrate head 80 between a horizontal position and an inclined position that is inclined a predetermined angle from the horizontal position. The turning mechanism 121 comprises a head turning servomotor 123 and a turn shaft 125 that is angularly moved by the head turning servomotor 123. The swinging mechanism 111 is fixed to the upper end of the turn shaft 125. The lifting/lowering mechanism 131 comprises a head lifting/lowering cylinder 133 and a rod 135 that can be lifted and lowered by the head lifting/lowering cylinder 133. The turning mechanism 121 is fixed to a stay 137 mounted on a distal end of the rod 135.

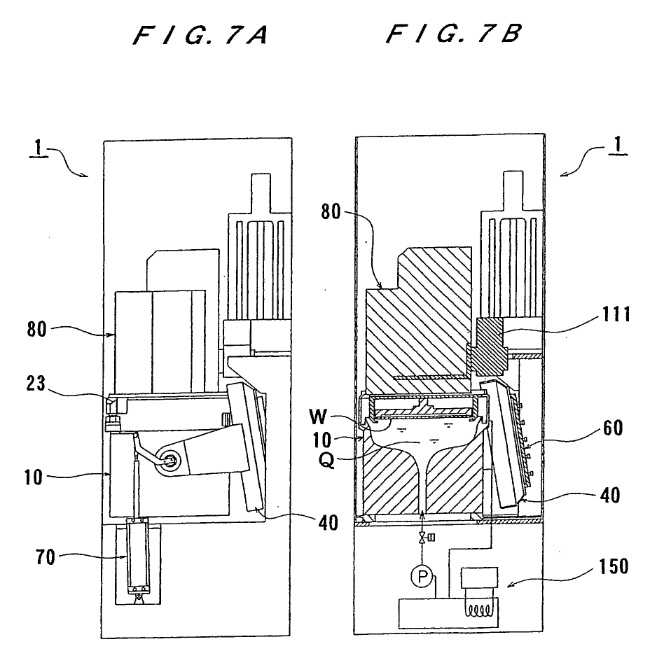

Overall operation of the substrate processing apparatus 1 will be described below. In FIGS. 1A and 1B, the cover 40 is shown as being turned to open the opening 11 of the processing tank 10, and the substrate head 80 is shown as being lifted. The cover 40 is thus moved to a retracted position on one side of the processing tank 10. The cover 40 is turned in a space which is created between the substrate head 80 and the processing tank 10 when the substrate head 80 is lifted. At this time, the processing liquid circulating system 150 has been actuated to circulate the plating solution Q between the processing tank 10 and the supply tank 151, while the plating solution Q is being maintained at a predetermined temperature. An unprocessed substrate W is attracted to the suction head 89 according to the process described above. Then, the swinging mechanism 111 swings the substrate head 80 in its entirety to tilt the substrate W a predetermined angle from the horizontal position, and the lifting/lowering mechanism 131 (see FIG. 6) is actuated to lower the substrate head 80 to the position shown in FIGS. 7A and 7B, in which the substrate W is dipped in the plating solution Q. After the substrate W is dipped, the swinging mechanism 111 swings the substrate head 80 in its entirety back to the original position to bring the substrate W into the horizontal position, in which the substrate W is subjected to electroless plating. At this time, the substrate rotating motor 101 shown in FIGS. 3A and 3B is energized to rotate the substrate W. In the substrate processing apparatus 1, since the substrate W is dipped in the plating solution Q while being tilted a predetermined angle from the horizontal position, a gas such as air or the like is prevented from remaining onto the surface to be processed of the substrate W. Specifically, if the substrate W were dipped in the plating solution Q while being in the horizontal position, then a gas such as air or the like would remain between the substrate W and the plating solution Q, preventing the substrate W from being uniformly plated. In the substrate processing apparatus 1, when the substrate W is dipped in the plating solution Q, the substrate W is tiled to prevent a gas such as air or the like from entering between the substrate W and the plating solution Q, thus allowing the substrate W to be uniformly plated.

After the electroless plating (first process) has been carried out onto the surface (lower surface) to be processed of the substrate W for a predetermined period of time, as described above, the lifting/lowering mechanism 131 (see FIG. 6) is actuated to lift the substrate head 80 to the position shown in FIGS. 1A and 1B. While the substrate W is being lifted, the rinsing nozzle 23 mounted on the processing tank 10 ejects a shot of cleaning liquid (pure water) to the surface to be processed of the substrate W which is being lifted. If the substrate W were not cooled immediately after the electroless plating is completed, then the electroless plating would still go on with the plating solution Q remaining on the substrate W. According to the present embodiment, the electroless plating is prevented from going on by ejecting a shot of cleaning liquid to the surface to be processed of the substrate W to cool the substrate W immediately after the electroless plating is completed.

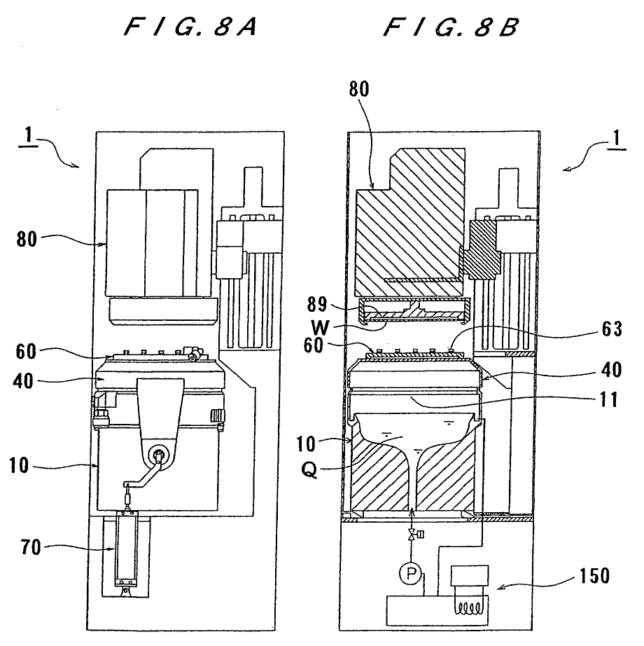

Then, the actuating mechanism 70 is actuated to turn the cover 40 to cover the opening 11 of the processing tank 10 with the cover 40, as shown in FIGS. 8A and 8B. Specifically, the cover 40 is moved to a closed position over the processing tank 10, closing the opening 11 of the processing tank 10. Then, the nozzles 63 of the spraying nozzle 60 fixedly mounted on the upper surface of the cover 40 spray the cleaning liquid (pure water) directly upwardly. The sprayed cleaning liquid is brought into contact with and cleans the processed surface of the substrate W. At this time, since the opening 11 of the processing tank 10 is covered with the cover 40, the cleaning liquid does not find its way into the processing tank 10. Therefore, the plating solution Q in the processing tank 10 is not diluted by the cleaning liquid, and hence can be used in circulation. According to the present embodiment, in particular, as shown in FIG. 2, inasmuch as the outer wall surface (outside diameter L1) at the upper end of the opening 11 is positioned inwardly of the inner wall surface (inside diameter L2) of the cover 40 which covers the upper end of the opening 11 (L1<L2), the cleaning liquid flowing down along the outer circumferential surface of the cover 40 falls, of necessity, over the outer wall surface at the upper end of the opening 11, and does not enter the opening 11. After having cleaned the substrate W, the cleaning liquid is discharged from a drain port (not shown). The substrate W which has been cleaned, as described above, is removed from the substrate head 80 as described above. A next unprocessed substrate W is then installed in the substrate head 80, and will be plated and cleaned as described above.

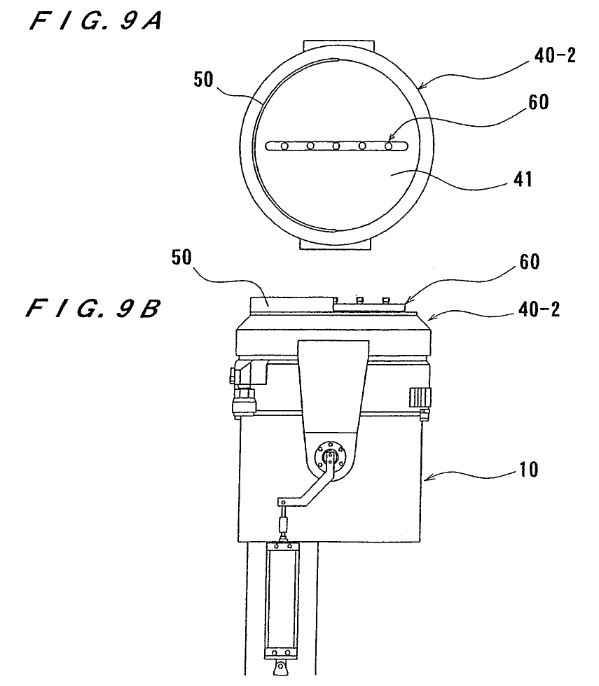

As shown in FIG. 2, the cover 40 according to the present embodiment is of such a shape that the tapered slanted panel 42 interconnects the flat upper panel 41 on which the spraying nozzle 60 is mounted and the cylindrical side panel 43. As described above, the corners (on sides and vertexes thereof) of the mount block 61 of the spraying nozzle 63 are rounded off to prevent the liquid sprayed by the spraying nozzle 60 from remaining on the cover 40. Therefore, when the cover 40, which closes the opening 11, is turned, the liquid on the cover 40 does not fall into the opening 11. FIGS. 9A and 9B-FIGS. 14A through 14D show various examples which are designed to prevent the liquid on the cover 40 from falling into the opening 11 when the cover 40 which closes the opening 11 is turned.

FIGS. 9A and 9B show a cover 40-2 having a semiarcuate bank 50 provided on an upper surface 41 thereof in surrounding relation to the spraying nozzle 60. The bank 50 has a height of several mm and is mounted on a region of the cover 40-2 which is lifted upwardly when the cover 40-2 is turned (a region which is about one half from the central position of the cover 40-2). When the cover 40-2 is turned, the liquid remaining on the cover 40-2 is prevented from falling off the cover 40-2 by the bank 50, but reliably falls off in the direction in which the cover 40-2 is tilted, thus avoiding the danger of the liquid flowing into the processing tank 10.

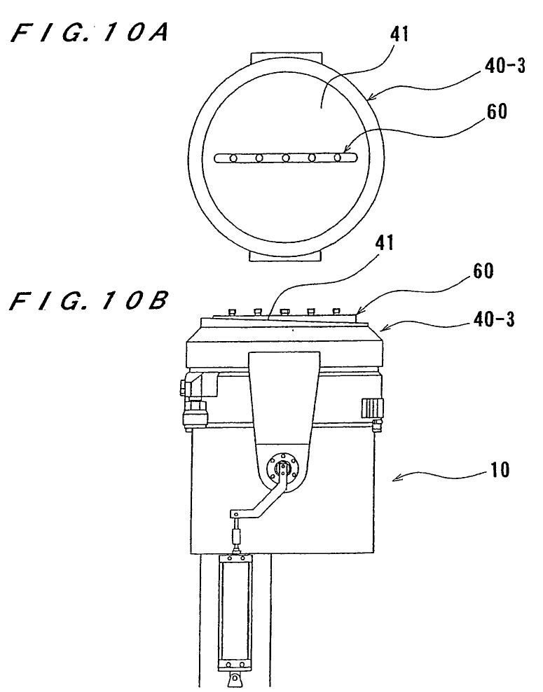

FIGS. 10A and 10B show a cover 40-3 having an upper surface (nozzle mount surface) 41 which is slanted in its entirety. The upper surface 41 is slanted such that it is lowered in one direction in which it faces downwardly when the cover 40-3 is turned. When the substrate is cleaned (when the cleaning liquid is sprayed by the spraying nozzle 60), the cleaning liquid (pure water or another liquid) falling onto the upper surface 41 of the cover 40-3 flows down along the slanted upper surface 41, but is prevented from remaining on the upper surface 41. As a result, when the cover 40-3 is turned, the liquid remaining on the upper surface 41 is prevented from flowing into the processing tank 10.

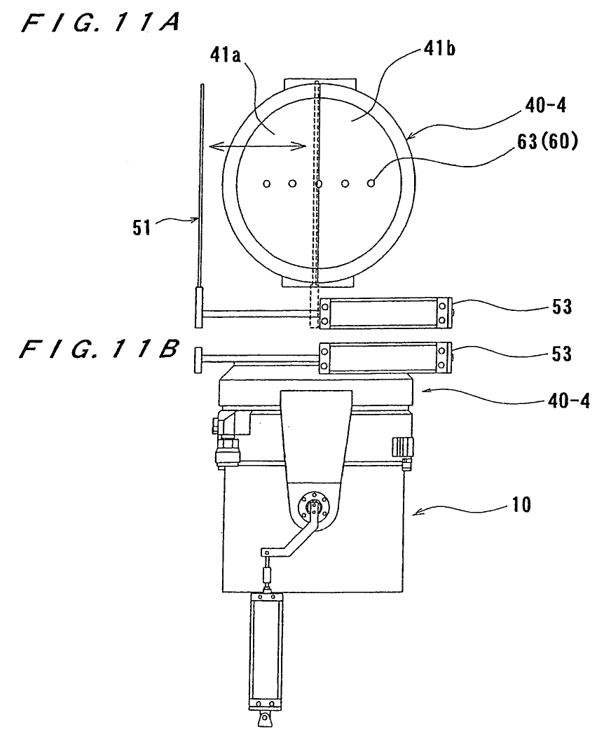

FIGS. 11A and 11B show a cover 40-4 having a wiper 51 disposed over an upper surface thereof and actuatable by an actuator 53 such as a cylinder or the like. The actuator 53 moves the wiper 51 horizontally on the upper surface of the cover 40-4 for removing a remaining liquid on the upper surface of the cover 40-4. In this example, the wiper 51 moves from an end of the cover 40-4 (the solid-line position in FIG. 11A) to the central position of the cover 40-4 (the dotted-line position in FIG. 11B). The upper surface 41 of the cover 40-4 includes a horizontal half surface 41a which is held in sliding contact with the wiper 51 and a slanted half surface 41b which is not held in sliding contact with the wiper 51. The spraying nozzle 60 (nozzles 63) is embedded in the cover 40-4 or otherwise located so as not to interfere with operation of the wiper 51. After completion of the cleaning with the spraying nozzle 60 (or process by another chemical liquid), the wiper 51 is operated to move from the end of the cover 40-4 to the central position of the cover 40-4, thus forcing any remaining liquid on the surface 41a onto the surface 41b, from which the liquid flows off. According to the cover 40-4, space occupied by the cover 40-4 is small, because the stroke of the wiper 51 is short. Alternatively, the entire upper surface 41 of the cover 40-4 may be a horizontal surface, and the wiper 51 may move from one end to the other end of the cover 40-4. According to this alternative, though the wiper 51 has a longer stroke, the wiper 51 acts on the entire upper surface of the cover 40-4.

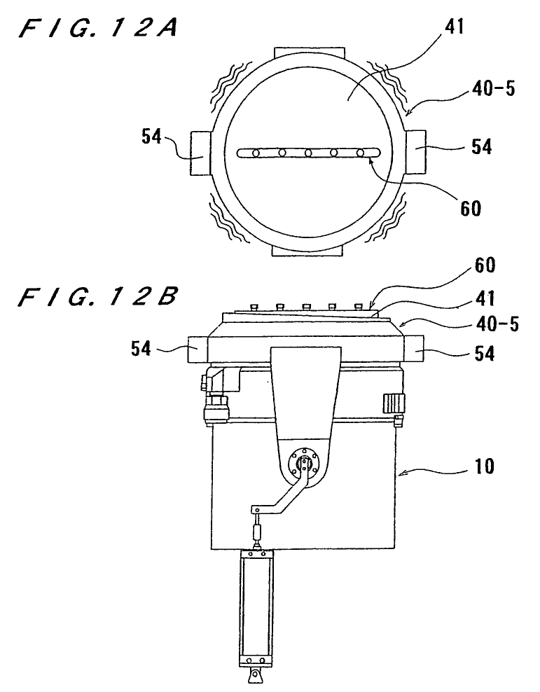

FIGS. 12A and 12B show a cover 40-5 having two vibrators 54 and an entire upper surface 41 which is slanted in one direction. After completion of the cleaning with the spraying nozzle 60 (or process by another chemical liquid), the vibrators 54 are operated to vibrate the cover 40-5 for forcing any remaining liquid on the cover 40-5 off the slanted upper surface 41. Since the entire upper surface 41 of the cover 40-5 is slanted, the remaining liquid can efficiently be forced off the upper surface 41.

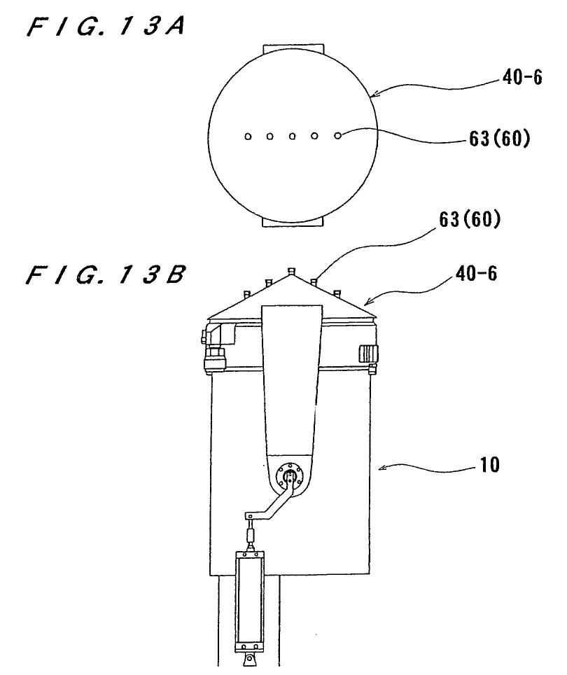

FIGS. 13A and 13B show a cover 40-6 having a conical shape. The cleaning liquid (or another chemical liquid) that has fallen onto the upper surface of the cover 40-6 flows down along the conical shape and falls outside of the processing tank 10.

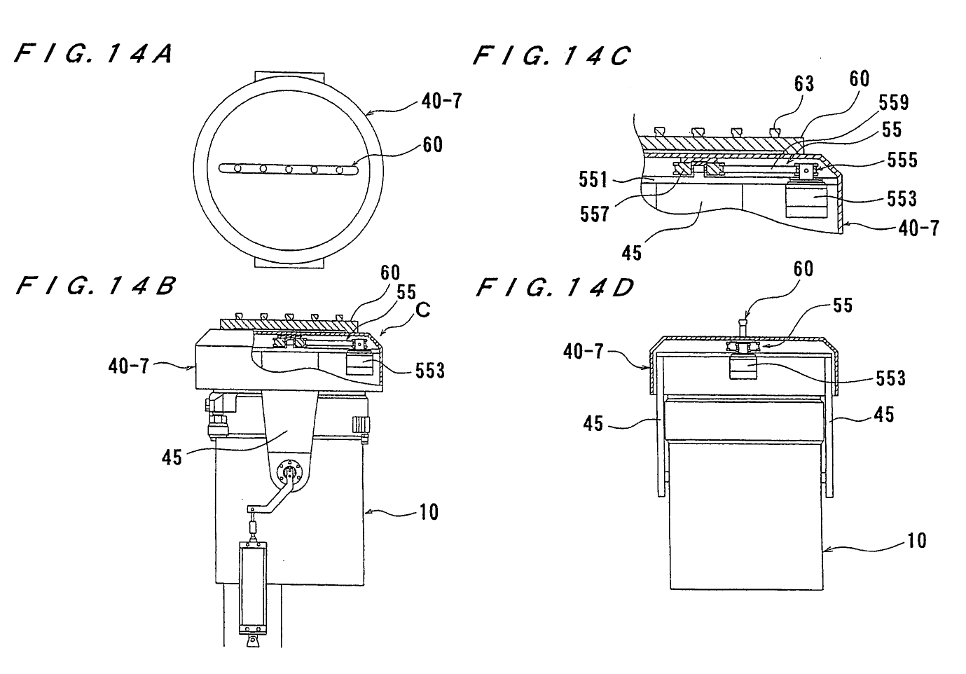

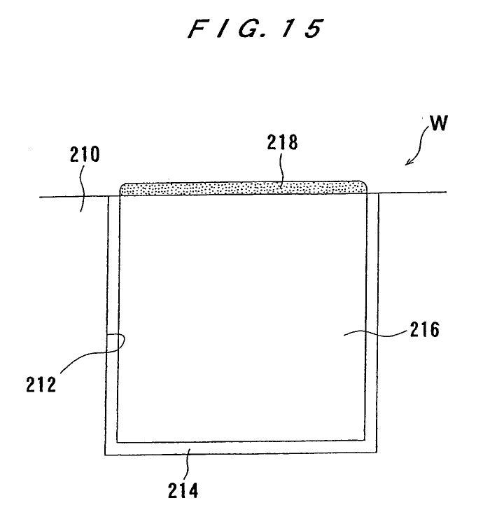

FIGS. 14A through 14D show a cover 40-7 having a cover rotating mechanism 55. The cover rotating mechanism 55 has a plate 551 fixed to the arms 45, a motor 553 fixedly mounted on the plate 551, a pulley 555 fixed to the shaft of the motor 553, a pulley 557 fixed to a central rotatable shaft mounted on the cover 40-7 placed over the pulley 557, and a belt 559 trained around the pulleys 555, 557. After the substrate is processed with the cleaning liquid or another chemical liquid sprayed by the spraying nozzle 60, the motor 553 is energized to rotate the cover 40-7 for forcibly spinning off any remaining liquid on the upper surface of the cover 40-7 under centrifugal forces. The cover rotating mechanism 55 may be structurally modified in various ways, and may comprise any mechanism insofar as it can rotate the cover 40-7.

In the above embodiment, the substrate is subjected to electroless plating in the plating solution Q stored in the processing tank 10. However, an anode may be disposed in the processing tank 10 and a cathode electrode may be connected to the substrate W for electroplating on the surface to be processed of the substrate W. The substrate processing apparatus 1 may be used not as a plating apparatus, but as a substrate processing apparatus for processing a substrate with a chemical liquid (e.g., for preprocessing before plating or postprocessing after plating). The process of processing the substrate W with the spraying nozzle (processing liquid ejecting section, second processing section) 60 is not limited to a process of cleaning a substrate with a cleaning liquid, but may be any of various processes of processing a substrate with chemical liquids.

[Substrate Processing Mechanism Using the Substrate Processing Apparatus 1]

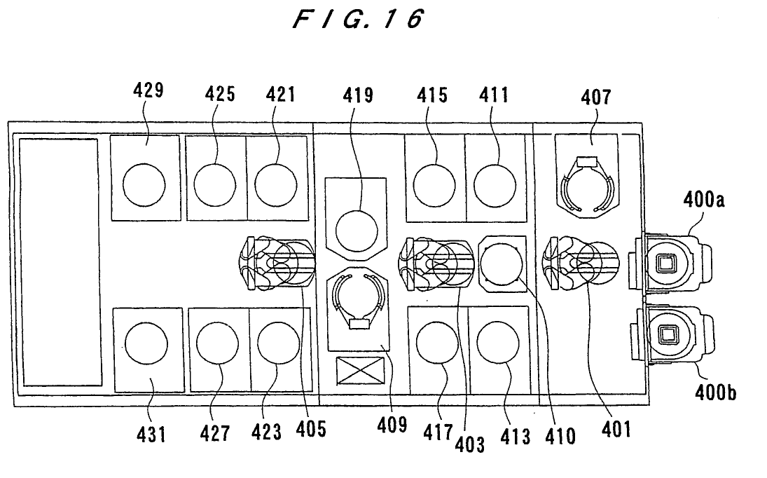

FIG. 16 is a plan view showing the layout of a substrate processing mechanism (cap plating apparatus) which incorporates the substrate processing apparatus 1 according to the above embodiment. As shown in FIG. 16, the substrate processing mechanism comprises a loading unit 400a and an unloading unit 400b for loading and unloading substrate cassettes which house substrates W, three transfer sections (transfer robots) 401, 403, 405 for transferring a substrate W, two reversing machines 407, 409, a temporary placing table 410, two drying units 411, 413, two cleaning units 415, 417, a substrate preprocessing apparatus 419 using a chemical liquid (e.g., dilute sulfuric acid), two substrate preprocessing apparatuses 421, 423 using a chemical liquid (e.g., palladium acetate), two substrate preprocessing apparatus 425, 427 using a chemical liquid (e.g., citrate), and two electroless plating apparatus 429, 431. Each of the electroless plating apparatus 429, 431 comprises the substrate processing apparatus 1 according to the above embodiment.

First, the transfer section 401 takes out a substrate W from the loading unit 400a, and transfers the substrate W to the reversing machine 407. The reversing machine 407 reverses the substrate W, which is then placed on the temporary placing table 410 by the transfer section 401. The substrate W on the temporary placing table 410 is transferred to the substrate preprocessing apparatus 419 by the transfer section 403. The substrate preprocessing apparatus 419 processes the surface to be processed of the substrate W with a chemical liquid (e.g., dilute sulfuric acid), and cleans the processed substrate W with a cleaning liquid.

The cleaned substrate W is then transferred by the transfer section 405 to one of the substrate preprocessing apparatus 421, 423, which processes the surface S to be processed of the substrate W with a chemical liquid (e.g., palladium acetate), and thereafter cleans the processed substrate W with a cleaning liquid. The cleaned substrate W is then transferred by the transfer section 405 to one of the substrate preprocessing apparatus 425, 427, which processes the surface S to be processed of the substrate W with a chemical liquid (e.g., citrate), and thereafter cleans the processed substrate W with a cleaning liquid.

The cleaned substrate w is then transferred by the transfer section 405 to one of the electroless plating apparatus 429, 431, which effects electroless plating (cap plating) onto the substrate W and cleans the substrate W. The cleaned substrate W is transferred to the reversing machine 409 by the transfer section. 405, which reverses the substrate. The reversed substrate W is transferred by the transfer section 403 to one of the cleaning units 417, 415; which cleans the substrate W with a roll brush. The cleaned substrate W is transferred by the transfer section 403 to one of the drying unit 413, 411, which cleans and then spin-dries the substrate W. The substrate W is then transferred to the unloading unit 400b by the transfer section 401.

The substrate processing apparatus 1 may also be used as each of the substrate preprocessing apparatus 419, 421, 423, 425, 427.

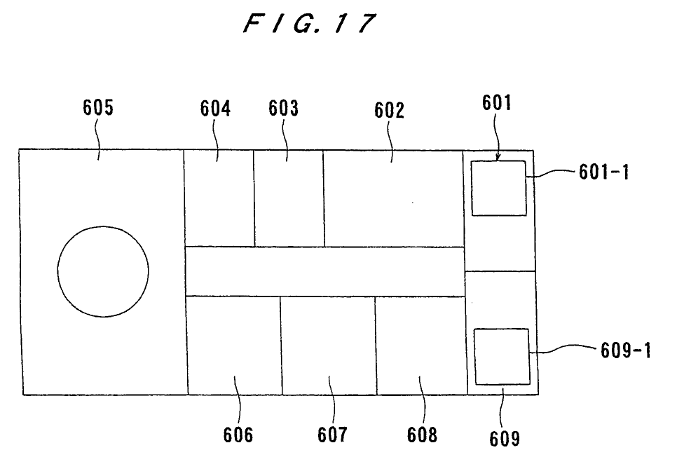

FIG. 17 is a plan view of another example of a substrate processing mechanism. The substrate processing mechanism shown in FIG. 17 comprises a loading unit 601 for loading a semiconductor substrate, a copper plating chamber 602, which comprises the substrate processing apparatus 1 according to the present invention, for plating a semiconductor substrate with copper, a pair of water cleaning chambers 603, 604 for cleaning a semiconductor substrate with water, a chemical mechanical polishing (CMP) unit 605 for chemically and mechanically polishing a semiconductor substrate, a pair of water cleaning chambers 606, 607 for cleaning a semiconductor substrate with water, a drying chamber 608 for drying a semiconductor substrate, and an unloading unit 609 for unloading a semiconductor substrate with an interconnection film thereon. The substrate plating apparatus also has a substrate transfer mechanism (not shown) for transferring semiconductor substrates to the chambers 602, 603, 604, the chemical mechanical polishing unit 605, the chambers 606, 607, 608, and the unloading unit 609. The loading unit 601, the chambers 602, 603, 604, the chemical mechanical polishing unit 605, the chambers 606, 607, 608, and the unloading unit 609 are combined into a single unitary arrangement as an apparatus. In this example, each of bellow-described apparatus for performing various plating processes in the substrate processing mechanism may comprise the substrate processing apparatus 1 according to the present invention.

The substrate processing mechanism operates as follows: The substrate transfer mechanism transfers a semiconductor substrate W on which an interconnection film has not yet been formed from a substrate cassette 601-1 placed in the loading unit 601 to the copper plating chamber 602. In the copper plating chamber 602, a plated copper film is formed on a surface of the semiconductor substrate W having an interconnection region composed of an interconnection trench and an interconnection hole (contact hole).

After the plated copper film is formed on the semiconductor substrate W in the copper plating chamber 602, the semiconductor substrate W is transferred to one of the water cleaning chambers 603, 604 by the substrate transfer mechanism and cleaned by water in one of the water cleaning chambers 603, 604. The cleaned semiconductor substrate W is transferred to the CMP unit 605 by the substrate transfer mechanism. The CMP unit 605 removes the unwanted plated copper film from the surface of the semiconductor substrate W, leaving a portion of the plated copper film in the interconnection trench and the interconnection hole.

Then, the semiconductor substrate W with the remaining plated copper film in the interconnection trench and the interconnection hole is transferred to one of the water cleaning chambers 606, 607 by the substrate transfer mechanism and cleaned by water in one of the water cleaning chambers 606, 607. The cleaned semiconductor substrate W is then dried in the drying chamber 608, after which the dried semiconductor substrate W with the remaining plated copper film serving as an interconnection film is placed into a substrate cassette 609-1 in the unloading unit 609.

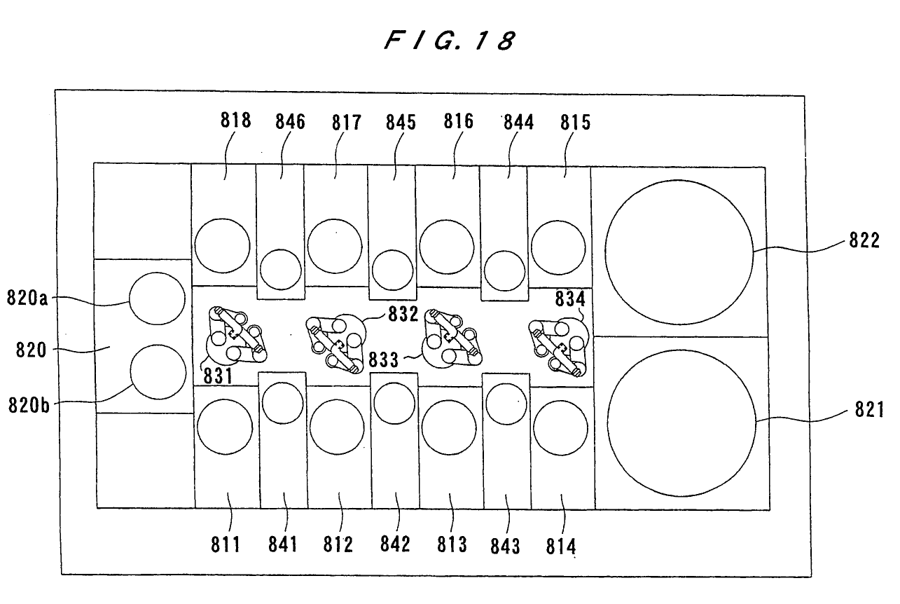

FIG. 18 is a plan view showing the layout of another example of the substrate processing mechanism. In the substrate processing mechanism, there are provided a barrier layer forming unit 811, a seed layer forming unit 812, a plating unit 813, an annealing unit 814, a first cleaning unit 815, a bevel and backside cleaning unit 816, a cap plating unit 817, a second cleaning unit 818, a first aligner and film thickness measuring instrument 841, a second aligner and film thickness measuring instrument 842, a first substrate reversing machine 843, a second substrate reversing machine 844, a substrate temporary placing table 845, a third film thickness measuring instrument 846, a loading/unloading section 820, a first polishing apparatus 821, a second polishing apparatus 822, a first robot 831, a second robot 832, a third robot 833, and a fourth robot 834. The film thickness measuring instruments 841, 842, and 846 are units, have the same size as the frontage dimension of other units (plating, cleaning, annealing units, and the like), and are thus interchangeable.

In this example, an electroless Ni—B plating apparatus can be used as the barrier layer forming unit 811, an electroless copper plating apparatus as the seed layer forming unit 812, and an electroplating apparatus as the plating unit 813.

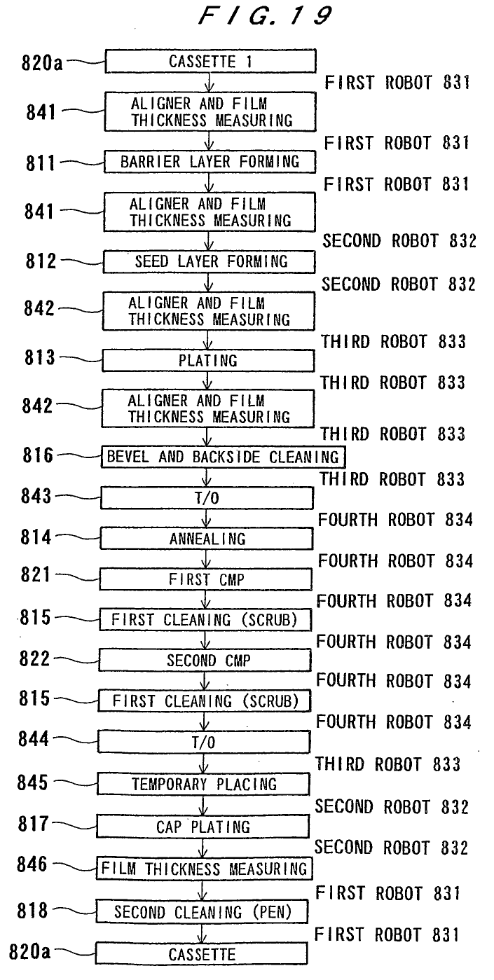

FIG. 19 is a flow chart showing the flow of the respective steps in the present substrate processing mechanism. The respective steps in the mechanism will be described according to this flow chart. First, a semiconductor substrate taken out by the first robot 831 from a cassette 820a placed on the loading/unloading section 820 is placed in the first aligner and film thickness measuring instrument 841, in such a state that its surface, to be plated, faces upward. In order to set a reference point for a position at which film thickness measurement is made, notch alignment for film thickness measurement is performed, and then film thickness data on the semiconductor substrate before formation of a copper film are obtained.

Then, the semiconductor substrate is transferred to the barrier layer forming unit 811 by the first robot 831. The barrier layer forming unit 811 is such an apparatus for forming a barrier layer on the semiconductor substrate by electroless Ni—B plating, and the barrier layer forming unit 811 forms a Ni—B film as a film for preventing copper from diffusing into an interlayer insulator film (e.g. SiO₂) of a semiconductor device. The semiconductor substrate discharged after cleaning and drying steps is transferred by the first robot 831 to the first aligner and film thickness measuring instrument 841, where the film thickness of the semiconductor substrate, i.e., the film thickness of the barrier layer is measured.

The semiconductor substrate after film thickness measurement is carried into the seed layer forming unit 812 by the second robot 832, and a seed layer is formed on the barrier layer by electroless copper plating. The semiconductor substrate discharged after cleaning and drying steps is transferred by the second robot 832 to the second aligner and film thickness measuring instrument 842 for determination of a notch position, before the semiconductor substrate is transferred to the plating unit 813, and then notch alignment for copper plating is performed by the film thickness measuring instrument 842. If necessary, the film thickness of the semiconductor substrate before formation of a copper film may be measured again in the film thickness measuring instrument 842.

The semiconductor substrate which has completed notch alignment is transferred by the third robot 833 to the plating unit 813 where copper plating is applied to the semiconductor substrate. The semiconductor substrate discharged after cleaning and drying steps is transferred by the third robot 833 to the bevel and backside cleaning unit 816 where an unnecessary copper film (seed layer) at a peripheral portion of the semiconductor substrate is removed. In the bevel and backside cleaning unit 816, the bevel is etched in a preset time, and copper adhering to the backside of the semiconductor substrate is cleaned with a chemical liquid such as hydrofluoric acid. At this time, before transferring the semiconductor substrate to the bevel and backside cleaning unit 816, film thickness measurement of the semiconductor substrate may be made by the second aligner and film thickness measuring instrument 842 to obtain the thickness value of the copper film formed by plating, and based on the obtained results, the bevel etching time may be changed arbitrarily to carry out etching. The region etched by bevel etching is a region which corresponds to a peripheral edge portion of the substrate and has no circuit formed therein, or a region which is not utilized finally as a chip although a circuit is formed. A bevel portion is included in this region.

The semiconductor substrate discharged after cleaning and drying steps in the bevel and backside cleaning unit 816 is transferred by the third robot 833 to the substrate reversing machine 843. After the semiconductor substrate is turned over by the substrate reversing machine 843 to cause the plated surface to be directed downward, the semiconductor substrate is introduced into the annealing unit 814 by the fourth robot 834 for thereby stabilizing a interconnection portion. Before and/or after annealing treatment, the semiconductor substrate is carried into the second aligner and film thickness measuring instrument 842 where the film thickness of a copper film formed on the semiconductor substrate is measured. Then, the semiconductor substrate is carried by the fourth robot 834 into the first polishing apparatus 821 in which the copper film and the seed layer of the semiconductor substrate are polished.

At this time, desired abrasive grains or the like are used, but fixed abrasive may be used in order to prevent dishing and enhance flatness of the surface. After completion of primary polishing, the semiconductor substrate is transferred by the fourth robot 834 to the first cleaning unit 815 where it is cleaned. This cleaning is scrub-cleaning in which rolls having substantially the same length as the diameter of the semiconductor substrate are placed on the face and the backside of the semiconductor substrate, and the semiconductor substrate and the rolls are rotated, while pure water or deionized water is flowed, thereby performing cleaning of the semiconductor substrate.

After completion of the primary cleaning, the semiconductor substrate is transferred by the fourth robot 834 to the second polishing apparatus 822 where the barrier layer on the semiconductor substrate is polished. At this time, desired abrasive grains or the like are used, but fixed abrasive may be used in order to prevent dishing and enhance flatness of the surface. After completion of secondary polishing, the semiconductor substrate is transferred by the fourth robot 834 again to the first cleaning unit 815 where scrub-cleaning is performed. After completion of cleaning, the semiconductor substrate is transferred by the fourth robot 834 to the second substrate reversing machine 844 where the semiconductor substrate is reversed to cause the plated surface to be directed upward, and then the semiconductor substrate is placed on the substrate temporary placing table 845 by the third robot 833.

The semiconductor substrate is transferred by the second robot 832 from the substrate temporary placing table 845 to the cap plating unit 817 where Ni—B plating is applied onto the copper surface with the aim of preventing oxidation of copper due to the atmosphere. The semiconductor substrate to which cap plating has been applied is carried by the second robot 832 from the cap plating unit 817 to the third film thickness measuring instrument 846 where the thickness of the copper film is measured. Thereafter, the semiconductor substrate is carried by the first robot 831 into the second cleaning unit 818 where it is cleaned with pure water or deionized water. The semiconductor substrate after completion of cleaning is returned into the cassette 820a placed on the loading/unloading section 820.

The aligner and film thickness measuring instrument 841 and the aligner and film thickness measuring instrument 842 perform positioning of the notch portion of the substrate and measurement of the film thickness.

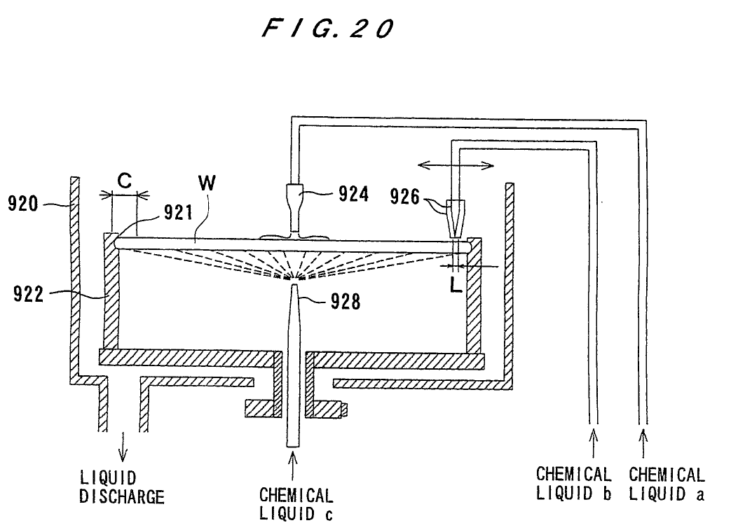

The bevel and backside cleaning unit 816 can perform an edge (bevel) copper etching and a backside cleaning at the same time, and can suppress growth of a natural oxide film of copper at the circuit formation portion on the surface of the substrate. FIG. 20 shows a schematic view of the bevel and backside cleaning unit 816. As shown in FIG. 20, the bevel and backside cleaning unit 816 has a substrate holder 922 positioned inside a bottomed cylindrical waterproof cover 920 and adapted to rotate a substrate W at a high speed, in such a state that the surface of the substrate W faces upwardly, while holding the substrate W horizontally by spin chucks 921 at a plurality of locations along a circumferential direction of a peripheral edge portion of the substrate, a center nozzle 924 placed above a nearly central portion of the face of the substrate W held by the substrate holder 922, and an edge nozzle 926 placed above the peripheral edge portion of the substrate W. The center nozzle 924 and the edge nozzle 926 are directed downward. A back nozzle 928 is positioned below a nearly central portion of the backside of the substrate W, and directed upward. The edge nozzle 926 is adapted to be movable in a diametrical direction and a height direction of the substrate W.

The width of movement L of the edge nozzle 926 is set such that the edge nozzle 926 can be arbitrarily positioned in a direction toward the center from the outer peripheral end surface of the substrate, and a set value for L is inputted according to the size, usage, or the like of the substrate W. Normally, an edge cut width C is set in the range of 2 mm to 5 mm. In the case where a rotational speed of the substrate is a certain value or higher at which the amount of liquid migration from the backside to the face is not problematic, the copper film within the edge cut width C can be removed.

Next, the method of cleaning with this bevel and backside cleaning unit will be described. First, the semiconductor substrate W is horizontally rotated integrally with the substrate holder 922, with the substrate being held horizontally by the spin chucks 921 of the substrate holder 922. In this state, an acid solution is supplied from the center nozzle 924 to the central portion of the face of the substrate W. The acid solution may be a non-oxidizing acid, and hydrofluoric acid, hydrochloric acid, sulfuric acid, citric acid, oxalic acid, or the like is used. On the other hand, an oxidizing agent solution is supplied continuously or intermittently from the edge nozzle 926 to the peripheral edge portion of the substrate W. As the oxidizing agent solution, one of an aqueous solution of ozone, an aqueous solution of hydrogen peroxide, an aqueous solution of nitric acid, and an aqueous solution of sodium hypochlorite is used, or a combination of these is used.

In this manner, the copper film, or the like formed on the upper surface and end surface in the region of the peripheral edge portion of the semiconductor substrate W is rapidly oxidized with the oxidizing agent solution, and is simultaneously etched with the acid solution supplied from the center nozzle 924 and spread on the entire face of the substrate, whereby it is dissolved and removed. By mixing the acid solution and the oxidizing agent solution at the peripheral edge portion of the substrate, a steep etching profile can be obtained, in comparison with a mixture of them which is produced in advance being supplied. At this time, the copper etching rate is determined by their concentrations. If a natural oxide film of copper is formed in the circuit-formed portion on the surface of the substrate, this natural oxide is immediately removed by the acid solution spreading on the entire surface of the substrate according to rotation of the substrate, and does not grow any more. After the supply of the acid solution from the center nozzle 924 is stopped, the supply of the oxidizing agent solution from the edge nozzle 926 is stopped. As a result, silicon exposed on the surface is oxidized, and deposition of copper can be suppressed.

On the other hand, an oxidizing agent solution and a silicon oxide film etching agent are supplied simultaneously or alternately from the back nozzle 928 to the central portion of the backside of the substrate. Therefore, copper or the like adhering in a metal form to the backside of the semiconductor substrate W can be oxidized with the oxidizing agent solution, together with silicon of the substrate, and can be etched and removed with the silicon oxide film etching agent. This oxidizing agent solution is preferably the same as the oxidizing agent solution supplied to the surface, because the types of chemicals are decreased in number. Hydrofluoric acid can be used as the silicon oxide film etching agent, and if hydrofluoric acid is used as the acid solution on the surface of the substrate, the types of chemicals can be decreased in number. Thus, if the supply of the oxidizing agent is stopped first, a hydrophobic surface is obtained. If the etching agent solution is stopped first, a water-saturated surface (a hydrophilic surface) is obtained, and thus the backside surface can be adjusted to a condition which will satisfy the requirements of a subsequent process.

In this manner, the acid solution, i.e., etching solution is supplied to the substrate to remove metal ions remaining on the surface of the substrate W. Then, pure water is supplied to replace the etching solution with pure water and remove the etching solution, and then the substrate is dried by spin-drying. In this way, removal of the copper film in the edge cut width C at the peripheral edge portion on the face of the semiconductor substrate, and removal of copper contaminants on the backside are performed simultaneously to thus allow this treatment to be completed, for example, within 80 seconds. The etching cut width of the edge can be set arbitrarily (from 2 to 5 mm), but the time required for etching does not depend on the cut width.

Annealing treatment performed before the CMP process and after plating has a favorable effect on the subsequent CMP treatment and on the electrical characteristics of interconnection. Observation of the surface of broad interconnection (unit of several micrometers) after the CMP treatment without annealing showed many defects such as microvoids, which resulted in an increase in the electrical resistance of the entire interconnection. Execution of annealing ameliorated the increase in the electrical resistance. In the presence of annealing, thin interconnection showed no voids. Thus, the degree of grain growth is presumed to be involved in these phenomena. That is, the following mechanism can be speculated: Grain growth is difficult to occur in thin interconnection. In broad interconnection, on the other hand, grain growth proceeds in accordance with annealing treatment. During the process of grain growth, ultra-fine pores in the plated film, which are too small to be seen by the SEM (scanning electron microscope), gather and move upward, thus forming microvoid-like depressions in the upper part of the interconnection. The annealing conditions in the annealing unit 814 are such that hydrogen (2% or less) is added in a gas atmosphere, the temperature is in the range of 300° C. to 400° C., and the time is in the range of 1 to 5 minutes. Under these conditions, the above effects were obtained.

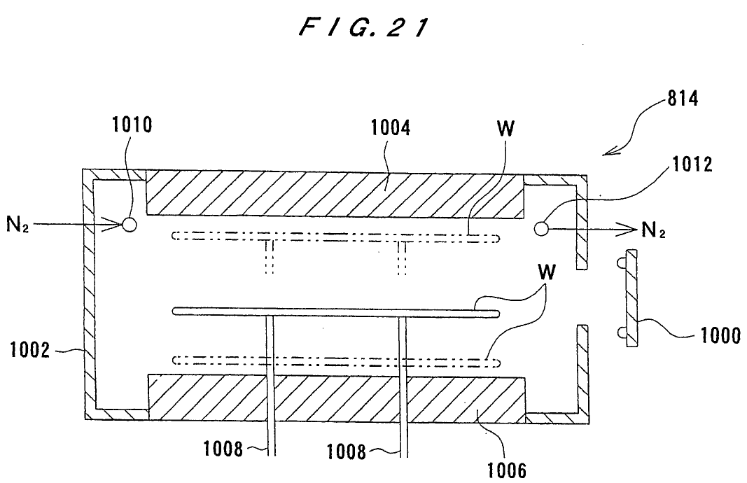

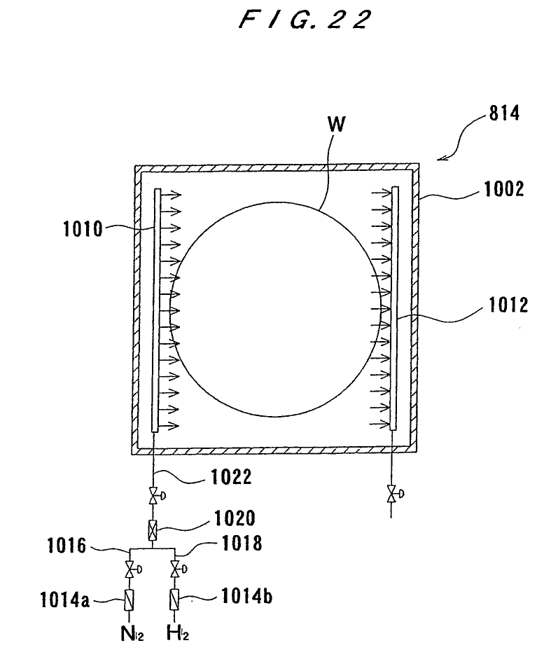

FIGS. 21 and 22 show the annealing unit 814. The annealing unit 814 comprises a chamber 1002 having a gate 1000 for taking in and taking out the semiconductor substrate W, a hot plate 1004 disposed at an upper position in the chamber 1002 for heating the semiconductor substrate W to e.g. 400° C., and a cool plate 1006 disposed at a lower position in the chamber 1002 for cooling the semiconductor substrate W by, for example, flowing a cooling water inside the plate. The annealing unit 814 also has a plurality of vertically movable elevating pins 1008 penetrating the cool plate 1006 and extending upward and downward therethrough for placing and holding the semiconductor substrate W on them. The annealing unit further includes a gas introduction pipe 1010 for introducing an antioxidant gas between the semiconductor substrate W and the hot plate 1004 during annealing, and a gas discharge pipe 1012 for discharging the gas which has been introduced from the gas introduction pipe 1010 and flowed between the semiconductor substrate W and the hot plate 1004. The pipes 1010 and 1012 are disposed on the opposite sides of the hot plate 1004.

The gas introduction pipe 1010 is connected to a mixed gas introduction line 1022 which in turn is connected to a mixer 1020 where a N₂ gas introduced through a N₂ gas introduction line 1016 containing a filter 1014a, and a H₂ gas introduced through a H₂ gas introduction line 1018 containing a filter 1014b, are mixed to form a mixed gas which flows through the line 1022 into the gas introduction pipe 1010.

In operation, the semiconductor substrate W, which has been carried in the chamber 1002 through the gate 1000, is held on the elevating pins 1008 and the elevating pins 1008 are raised up to a position at which the distance between the semiconductor substrate W held on the lifting pins 1008 and the hot plate 1004 becomes e.g. 0.1-1.0 mm. In this state, the semiconductor substrate W is then heated to e.g. 400° C. through the hot plate 1004 and, at the same time, the antioxidant gas is introduced from the gas introduction pipe 1010 and the gas is allowed to flow between the semiconductor substrate W and the hot plate 1004 while the gas is discharged from the gas discharge pipe 1012, thereby annealing the semiconductor substrate W while preventing its oxidation. The annealing treatment may be completed in about several tens of seconds to 60 seconds. The heating temperature of the substrate may be selected in the range of 100-600° C.

After completion of the annealing, the elevating pins 1008 are lowered down to a position at which the distance between the semiconductor substrate W held on the elevating pins 1008 and the cool plate 1006 becomes e.g. 0-0.5 mm. In this state, by introducing a cooling water into the cool plate 1006, the semiconductor substrate W is cooled by the cool plate to a temperature of 100° C. or lower in e.g. 10-60 seconds. The cooled semiconductor substrate is sent to the next step.

A mixed gas of N₂ gas with several % of H₂ gas is used as the above antioxidant gas. However, N₂ gas may be used singly.

The annealing unit may be placed in the electroplating apparatus.

[Another Substrate Processing Apparatus 1-2]

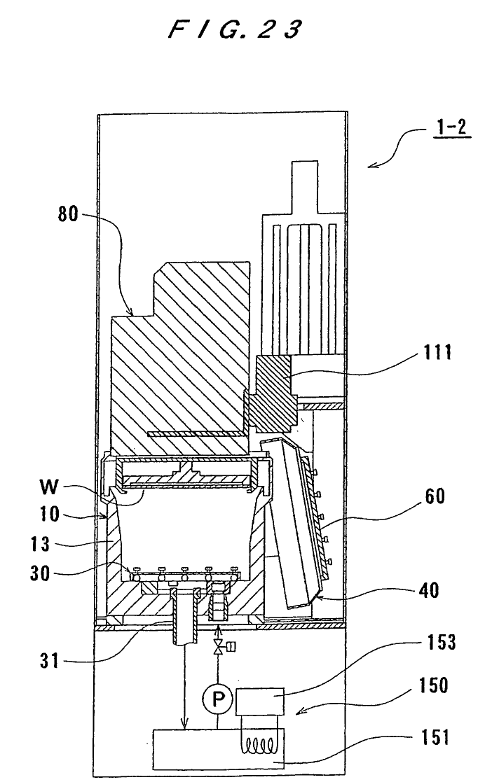

FIG. 23 is a sectional side view schematically showing a substrate processing apparatus 1-2 according to another embodiment of the present invention, the substrate processing apparatus 1-2 being shown in a state similar to the state shown in FIG. 7B. Those parts of the substrate processing apparatus 1-2 that are identical or correspond to those of the substrate processing apparatus 1 are denoted by identical reference characters, and will not be described in detail below. The substrate processing apparatus 1-2 differs from the substrate processing apparatus 1 as to internal structural details of the processing tank 10. Specifically, the substrate processing apparatus 1-2 has a container-shaped processing tank body 13 having a spraying nozzle (processing liquid ejecting section) 30 for spraying a plating solution (electroless plating solution), rather than storing a plating solution therein. The spraying nozzle 30 is supplied with the plating solution in the supply tank 151 by the pump P. The spraying nozzle 30 sprays the plating solution into contact with the surface to be processed of the substrate W which is lowered into the processing tank body 13, thus plating the substrate W. After having contacted the surface to be processed of the substrate W, the plating solution falls onto the bottom of the processing tank body 13, is returned to the supply tank 151 through a pipe 31, and is then supplied to the spraying nozzle 30 for circulation. The substrate processing apparatus 1-2 thus arranged is also capable of effecting electroless plating onto the surface to be processed of the substrate W.

The spraying nozzle 30 of the substrate processing apparatus 1-2 may be disposed in the processing tank body 13, which holds the plating solution Q, of the substrate processing apparatus 1 shown in FIG. 1, so that the substrate W can be dipped in the plating solution and the plating solution can be sprayed onto the substrate W by the spraying nozzle 30 in the single processing tank 10. This arrangement makes it possible to perform two processing methods in the single processing tank 10.

As with the substrate processing apparatus 1, the substrate processing apparatus 1-2 may be used not as a plating apparatus, but as a substrate processing apparatus for processing a substrate with a chemical liquid (e.g., for preprocessing before plating or postprocessing after plating). The process of processing the substrate W with the spraying nozzle 60 is not limited to a process of cleaning a substrate with a cleaning liquid, but may be any of various processes of processing a substrate with chemical liquids.

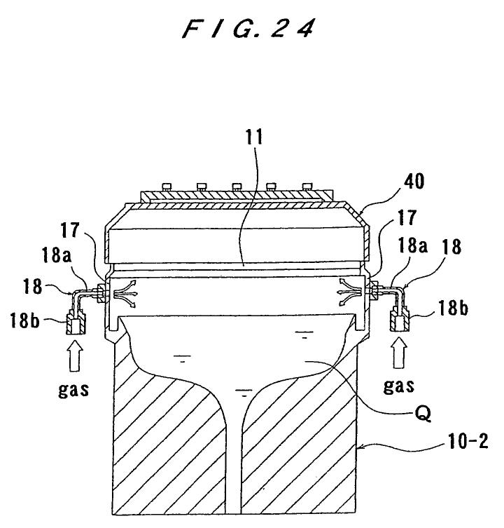

FIG. 24 shows another processing tank 10-2 and a cover 40. The processing tank 10-2 differs from the processing tank 10 of the substrate processing apparatus 1 shown in FIG. 1 in that a hood 17 of the processing tank 10-2 has gas ejecting sections 18 for ejecting a gas such as an inactive gas (e.g., nitrogen gas) into the processing tank 10-2. Each of the gas ejecting sections 18 comprises a passage 18a extending through the hood 17 to communicate between the interior and the exterior of the processing tank 10-2, and a joint 18b mounted on the tip end of the passage 18a. With the opening 11 covered with the cover 40, the gas ejecting sections 18 eject a gas such as an inactive gas into the processing tank 10-2, which seals the gas therein thereby to replace the atmosphere in the processing tank 10-2 with an inactive gas. Thus, the plating solution Q is prevented from contacting atmospheric oxygen and hence from having lowered functionality, so that the substrate W can be brought into contact with the normal plating solution Q at all times. The gas ejecting sections 18 may be structurally changed in various ways, and may be mounted on the over 40 or any of various other regions, rather than the hood 17.

The embodiments of the present invention have been described above. However, the present invention is not limited to the above embodiments, but various modifications may be made within the scope of claims for patent, and the scope of the technical concept described in the specification and drawings. Any configurations, structures, and materials which are not directly described in the specification and drawings fall within the scope of the technical concept of the present invention insofar as they exhibit operation and advantages of the present invention.

For example, although the cover 40 is turned by the actuating mechanism 70 in the above embodiments, the cover 40 may be of such a structure that it can be moved to two positions, i.e., a position in which it closes the opening 11 of the processing tank 10, and another position. For example, the cover 40 may be of such a structure that it can be translated, rather than turned.

In the above embodiments, the spraying nozzle 60 mounted on the upper surface of the cover 40 is employed as the second processing section. However, the spraying nozzle 60 may be installed on another member other than the upper surface of the cover 40 (e.g., an outer cover surrounding the substrate processing apparatus 1). The spraying nozzle 60 mounted on the cover 40 is suitable for reducing the size of the substrate processing apparatus 1.

According to the present invention, as described in detail above, even if a substrate is processed by a plurality of processing liquids within one apparatus, the processing liquids are prevented from being mixed with each other, and an installation area for the apparatus may be reduced in size and the cost of the apparatus may be lowered.

### Industrial Applicability

The present invention relates to a substrate processing apparatus and substrate processing method which are suitable for processing a substrate with a plurality of liquids.

1. An apparatus for processing a substrate, comprising:
a first processing section bringing a processing liquid into contact with a surface to be processed of a substrate in such a state that the substrate held by a substrate head is inserted in a processing tank;
a substrate lifting/lowering mechanism for vertically moving the substrate held by the substrate head;
a cover for selectively opening and closing an opening of the processing tank; and
a second processing section for bringing a processing liquid into contact with the surface to be processed of the substrate held by the substrate head, above the cover which has closed the opening of the processing tank.

2. An apparatus according to claim 1, wherein said first processing section is of a structure for holding the processing liquid in the processing tank and dipping the surface to be processed of the substrate in the processing liquid, thereby to bring the processing liquid into contact with the surface to be processed of the substrate.

3. An apparatus according to claim 2, wherein said processing tank is adapted to eject and seal a gas therein.

4. An apparatus according to claim 1, wherein said first processing section is of a structure for bringing a processing liquid, which is ejected from a processing liquid ejecting section disposed in the processing tank, into contact with the surface to be processed of the substrate.

5. An apparatus according to claim 1, further comprising a processing liquid circulating system for retrieving the processing liquid which has been supplied to the processing tank, and supplying the processing liquid to the processing tank.

6. An apparatus according to claim 1, wherein said substrate head is of a structure for attracting a reverse side of the substrate to hold the substrate, thereby to bring the processing liquid into contact with the entire surface to be processed of the substrate.

7. An apparatus according to claim 1, wherein said substrate head is of a structure for attracting only a reverse side of the substrate to hold the substrate, thereby to produce a uniform flow of the processing liquid to be brought into contact with the surface to be processed of the substrate, and bring the processing liquid into uniform contact with the entire surface to be processed of the substrate, including an edge of the substrate.

8. An apparatus according to claim 2, wherein said substrate head is provided with a swinging mechanism for dipping the substrate held by the substrate head in the processing liquid held in the processing tank, while the substrate is being inclined a predetermined angle from a horizontal position.

9. An apparatus according to claim 1, further comprising an actuating mechanism for moving the cover between two positions including a retracted position in which the cover is positioned on a side of the processing tank and a closing position in which the cover is positioned above the processing tank and closes the opening of the processing tank.

10. An apparatus according to claim 1, wherein a processing liquid ejecting section is provided on an upper surface of the cover for bringing the processing liquid into contact with the surface to be processed of the substrate while the cover is closing the opening of the processing tank.

11. An apparatus according to claim 1, wherein a bank is provided on an upper surface of the cover for preventing the processing liquid remaining on the upper surface of the cover from falling into the processing tank when the cover is opened from a state in which the cover closes the opening of the processing tank.

12. An apparatus according to claim 1, wherein said cover has an upper surface having a slanted shape or a conical shape for allowing the processing liquid on the upper surface of the cover to flow down while the cover is closing the opening of the processing tank.

13. An apparatus according to claim 1, further comprising a wiper, a vibrator, or a cover rotating mechanism for removing the processing liquid which remains on an upper surface of the cover.

14. An apparatus according to claim 1, wherein said processing tank has on an upper portion thereof a slanted wall having an outside diameter which is progressively smaller in an upward direction, such that an outer wall at an upper end of the opening of the processing tank is positioned inwardly of an inner wall of the cover which covers the upper end of the opening.

15. A method of processing a substrate, comprising:
bringing a processing liquid into contact with a surface to be processed of a substrate in such a state that the substrate held by a substrate head is inserted in a processing tank;
closing an opening of the processing tank with a cover in such a state that the substrate held by the substrate is lifted above the processing tank; and
bringing a processing liquid into contact with the surface to be processed of the substrate held by the substrate head, above the cover which has closed the opening of the processing tank.

16. A method according to claim 15, wherein the bringing the processing liquid into contact with the surface to be processed of the substrate in the processing tank comprises the steps of storing the processing liquid in the processing tank and dipping the surface to be processed of the substrate in the processing liquid.

17. A method according to claim 16, further comprising filling the processing tank with an inactive gas when the opening of the processing tank is closed by the cover, thereby protecting the processing liquid in the processing tank.

18. A method according to claim 15, wherein the bringing the processing liquid into contact with the surface to be processed of the substrate in the processing tank comprises a step of ejecting a processing liquid ejected from a processing liquid ejecting section disposed in the processing tank into contact with the surface to be processed of the substrate.

19. A method according to claim 15, further comprising retrieving the processing liquid which has been supplied to the processing tank and supplying the processing liquid to the processing tank.

20. A method according to claim 15, wherein said substrate head attracts a reverse side of the substrate to hold the substrate.

21. A method according to claim 15, wherein said substrate head attracts only a reverse side of the substrate to hold the substrate thereby to produce a uniform flow of the processing liquid to be brought into contact with the surface to be processed of the substrate, and bring the processing liquid into uniform contact with the entire surface to be processed of the substrate, including an edge of the substrate.

22. A method according to claim 21, wherein said uniform flow of the processing liquid discharges, from the surface to be processed, air bubbles flowing onto the surface to be processed of the substrate or air bubbles generated when the processing liquid is brought into contact with the surface to be processed of the substrate.

23. A method according to claim 16, wherein the dipping the surface to be processed of the substrate in the processing liquid comprises a step of dipping the surface to be processed of the substrate in the processing liquid in the processing tank while the substrate is being tilted.

24. A method according to claim 15, wherein the opening of the processing tank is selectively opened and closed by the cover by moving the cover between two positions including a retracted position in which the cover is positioned on a side of the processing tank and a closing position in which the cover is positioned above the processing tank and closes the opening of the processing tank.

25. A method according to claim 15, wherein the bringing the processing liquid into contact with the surface to be processed of the substrate above the cover comprises a step of ejecting a processing liquid ejected from a processing liquid ejecting section mounted on an upper surface of the cover to the substrate.
